(19) United States
(12) Patent Application Publication
(10) Pub. No.: US 2022/0274592 A1
(43) Pub. Date: Sep. 1, 2022

(54) VEHICLE PARKING NAVIGATION

(71) Applicant: Ford Global Technologies, LLC, Dearborn, MI (US)

(72) Inventors: Chenhao Ma, Canton, MI (US); Tony Tae-Jin Pak, Garden City, MI (US); Hamid M. Golgiri, Livonia, MI (US); Ahmed Benmimoun, Aachen (DE)

(73) Assignee: Ford Global Technologies, LLC, Dearborn, MI (US)

(21) Appl. No.: 17/186,087

(22) Filed: Feb. 26, 2021

(51) Int. Cl. B60W 30/095; B60W 30/06

(52) U.S. Cl. CPC B60W 30/095; B60W 30/06; B60W 2556/50; B60W 2554/40; B60W 2554/20

(57) ABSTRACT

A vehicle is operated along a segment of a stored travel path based on vehicle operating parameters for the segment. The stored travel path includes a risk level for the segment. The risk level for the segment is updated based on actuating a vehicle component to avoid an object along the segment. The vehicle operating parameters for the segment are updated based on the updated risk level. The vehicle is operated along the segment based on the updated vehicle operating parameters.

### BACKGROUND

A vehicle can be equipped with electronic and electro-mechanical components, e.g., computing devices, networks, sensors, controllers, etc. A vehicle computer can acquire data regarding the vehicle's environment and can operate the vehicle or at least some components thereof based on the acquired data. Vehicle sensors can provide data concerning routes to be traveled and objects to be avoided in the vehicle's environment. Operation of the vehicle can rely upon acquiring accurate and timely data regarding objects in a vehicle's environment while the vehicle is being operated.

### BRIEF DESCRIPTION OF THE DRAWINGS

FIG. 1 is a block diagram illustrating an example vehicle control system for a vehicle.

FIG. 2 is a diagram illustrating operating the vehicle according to the system of FIG. 1.

FIGS. 3A-3C are diagrams illustrating operating the vehicle along a segment of a stored travel path and updating the risk level for the segment.

FIG. 4 is a flowchart of an example process for determining a travel path for a vehicle.

FIG. 5 is a flowchart of an example process for updating a risk level for a segment of the travel path.

### DETAILED DESCRIPTION

A system includes a computer including a processor and a memory, the memory storing instructions executable by the processor to operate a vehicle along a segment of a stored travel path based on vehicle operating parameters for the segment. The stored travel path includes a risk level for the segment. The instructions further include instructions to update the risk level for the segment based on actuating a vehicle component to avoid an object along the segment. The instructions further include instructions to update the vehicle operating parameters for the segment based on the updated risk level. The instructions further include instructions to operate the vehicle along the segment based on the updated vehicle operating parameters.

The instructions can further include instructions to, upon updating the risk level for the segment, update a map to include the updated risk level.

The instructions can further include instructions to provide the updated map to a remote computer.

The instructions can further include instructions to determine the vehicle operating parameters for the segment based on the risk level for the segment.

The instructions can further include instructions to determine at least one of the vehicle operating parameters for the segment and the risk level for the segment based on operation data obtained while operating the vehicle along the segment in a training mode.

The instructions can further include instructions to determine the risk level for the segment based on receiving input specifying the risk level for the segment.

The instructions can further include instructions to update the risk level for the segment additionally based on determining that the segment extends through an intersection of two or more lanes.

The instructions can further include instructions to determine the stored travel path by recording a travel path along which the vehicle is operated in a training mode.

The instructions can further include instructions to determine, based on a map, the stored travel path.

The instructions can further include instructions to reset the updated risk level for the segment based on determining to not actuate the vehicle component to avoid a subsequent object along the segment for a predetermined time after actuating the vehicle component to avoid the object along the segment.

The system can include a remote computer including a second processor and a second memory storing instructions executable by the second processor to update a map based on aggregated data including messages from a plurality of vehicles indicating the updated risk level of the segment.

A method includes operating a vehicle along a segment of a stored travel path based on vehicle operating parameters for the segment. The stored travel path includes a risk level for the segment. The method further includes updating the risk level for the segment based on actuating a vehicle component to avoid an object along the segment. The method further includes updating the vehicle operating parameters for the segment based on the updated risk level. The method further includes operating the vehicle along the segment based on the updated vehicle operating parameters.

The method can further include, upon updating the risk level for the segment, updating a map to include the updated risk level and providing the updated map to a remote computer.

The method can further include determining the vehicle operating parameters for the segment based on the risk level for the segment.

The method can further include determining at least one of the vehicle operating parameters for the segment and the risk level for the segment based on operation data obtained while operating the vehicle along the segment in a training mode.

The method can further include determining the risk level for the segment based on receiving input specifying the risk level for the segment.

The method can further include updating the risk level for the segment additionally based on determining that the segment extends through an intersection of two or more lanes.

The method can further include determining the stored travel path by recording a travel path along the vehicle is operated in a training mode.

The method can further include determining, based on a map at least one of the stored travel path or the risk level for the segment.

The method can further include resetting the updated risk level for the segment based on determining to not actuate the vehicle component to avoid a subsequent object along the segment for a predetermined time after actuating the vehicle component to avoid the object along the segment.

Further disclosed herein is a computing device programmed to execute any of the above method steps. Yet further disclosed herein is a computer program product, including a computer readable medium storing instructions executable by a computer processor, to execute an of the above method steps.

A vehicle computer can operate a vehicle along a stored travel path in a parking area that includes a plurality of sub-areas, e.g., parking spaces. While operating along the stored travel path, the vehicle computer can search for available sub-areas, e.g., unoccupied parking spaces, via image data. The vehicle computer can determine the stored travel path by recording a travel path along which a user previously operated the vehicle. While the vehicle is operating along the stored travel path, fields of view of available vehicle sensors may define a blind zone around the vehicle within which the vehicle sensors cannot acquire data. An object may be in the blind zone and thus undetectable by the available sensors. In this situation, one or more objects, e.g., pedestrians and other vehicles, may move out of the blind zone and intersect a segment of the stored travel path. The vehicle computer may then perform a collision avoidance maneuver, i.e., actuate one or more vehicle components to update vehicle operation and avoid the object along the segment. Advantageously, upon performing the collision avoidance maneuver, the vehicle computer can update a risk level for the segment and update vehicle operating parameters for the segment based on the updated risk level. The vehicle computer can then operate the vehicle along the segment based on the updated vehicle operating parameters. By updating the vehicle operating parameters based on the risk level for the segment, the vehicle computer can operate the vehicle differently along segments of the stored travel path with relatively higher risk levels, which can reduce the likelihood of the vehicle impacting an object while operating along the stored travel path.

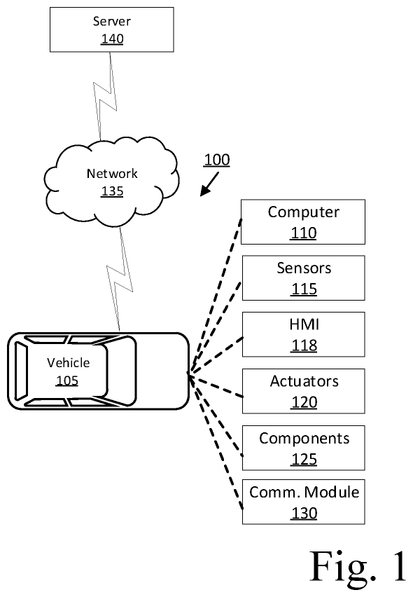

With reference to FIGS. 1-3A, an example vehicle control system 100 includes a vehicle 105. A vehicle computer 110 in the vehicle 105 receives data from sensors 115. The vehicle computer 110 is programmed to operate the vehicle 105 along a segment S of a stored travel path P based on vehicle operating parameters for the segment S. The stored travel path P includes a risk level for the segment S. The vehicle computer 110 is further programmed to update the risk level for the segment S based on actuating a vehicle component 125 to avoid an object 220 along the segment S. The vehicle computer 110 is further programmed to update the vehicle operating parameters for the segment S based on the updated risk level. The vehicle computer 110 is further programmed to operate the vehicle 105 along the segment S based on the updated vehicle operating parameters.

Turning now to FIG. 1, the vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above and/or may include a dedicated electronic circuit including an ASIC that is manufactured for a particular operation, e.g., an ASIC for processing sensor data and/or communicating the sensor data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the vehicle 105. As one example, the data may be image data of the environment around the vehicle 105. In such an example, the image data may include one or more objects and/or markings, e.g., lane markings, on or along a road. Image data herein means digital image data, e.g., comprising pixels with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

The vehicle 105 further includes a human-machine interface (HMI) 118. The HMI 118 includes user input devices such as knobs, buttons, switches, pedals, levers, touchscreens, and/or microphones, etc. The input devices may include sensors 115 to detect user inputs and provide user input data to the vehicle computer 110. That is, the vehicle computer 110 may be programmed to receive user input from the HMI 118. The user may provide each user input via the HMI 118, e.g., by selecting a virtual button on a touchscreen display, by providing voice commands, etc. For example, a touchscreen display included in an HMI 118 may include sensors 115 to detect that a user selected a virtual button on the touchscreen display to, e.g., select or deselect an operation, which input can be received in the vehicle computer 110 and used to determine the selection of the user input.

The HMI 118 typically further includes output devices such as displays (including touchscreen displays), speakers, and/or lights, etc., that output signals or data to the user. The HMI 118 is coupled to the vehicle communications network and can send and/or receive messages to/from the vehicle computer 110 and other vehicle sub-systems.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or DSRC., etc.) to another vehicle, and/or to a remote server computer 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or or some other wide area network.

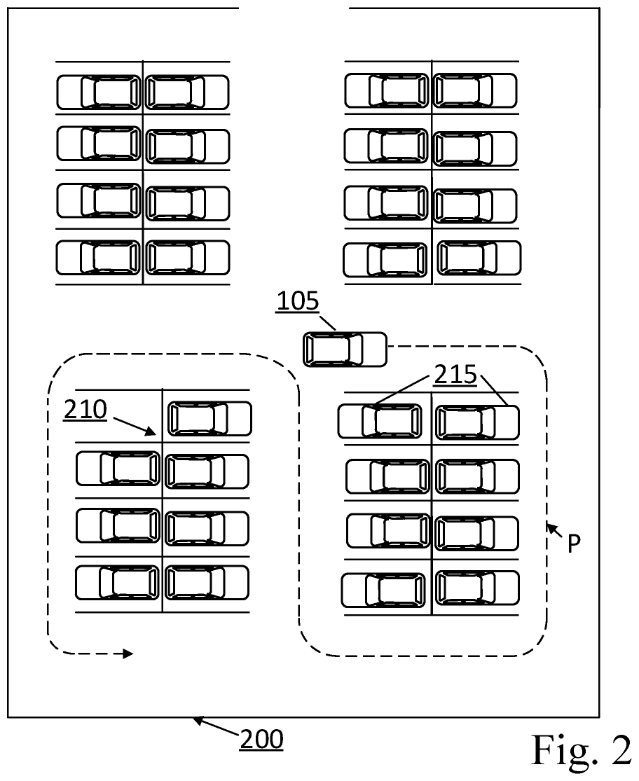

FIG. 2 is a diagram illustrating a vehicle 105 operating in an example parking area 200 that includes marked sub-areas 210 (e.g., parking spaces) for vehicles. The vehicle computer 110 is programmed to determine whether the vehicle 105 is in a road area (not shown) or a parking area 200. A road area is an area of ground surface that includes any paved or finished surface provided for land vehicle travel. A parking area 200 is a specified area of ground surface for parking a vehicle. The parking area 200 may be on a street or road, e.g., an area alongside a curb or an edge of the street, a parking lot or structure or portion thereof, etc. A sub-area 210 may, for example, be a parking space indicated by conventional markings, e.g., painted lines on a ground surface, and conventional image recognition techniques can be employed by the vehicle computer 110 to identify the sub-area 210.

The vehicle computer 110 may be programmed to determine that the vehicle 105 is within the parking area 200 or the road area based on sensor 115 data. For example, the vehicle computer 110 may be programmed to determine that the vehicle 105 is within the parking area 200 or road area by, e.g., GPS-based geo-fencing. A geo-fence herein has the conventional meaning of a boundary for an area defined by sets of geo-coordinates. In such an example, one geo-fence specifies a perimeter of the parking area 200 and another geo-fence specifies a perimeter of the road area. The vehicle computer 110 can then determine that the vehicle 105 is within the parking area 200 or the road area based on the location data of the vehicle 105 indicating the vehicle 105 is within the corresponding geo-fence. As another example, the vehicle computer 110 may determine whether the vehicle 105 is in the road area or the parking area 200 based on data, e.g., map data, received from the remote server computer 140. For example, the vehicle computer 110 may receive a location of the vehicle 105, e.g., from a sensor 115, a navigation system, a remote server computer 140, etc. The vehicle computer 110 can compare the location of the vehicle 105 to the map data, e.g., to determine whether the vehicle 105 is in the road area or the parking area 200 specified in the map data.

The vehicle computer 110 is programmed to transition a training mode between a disabled state and an enabled state based on the location of the vehicle 105. For example, upon determining that the vehicle 105 has moved into a parking area 200, the vehicle computer 110 can enable the training mode, i.e., transition the training mode from the disabled state to the enabled state. As another example, upon determining that the vehicle 105 has moved into a road area 205, the vehicle computer 110 disables the training mode, i.e., transitions the training mode from the enabled state to the disabled state. That is, the training mode is enabled when the vehicle 105 is in a parking area 200 and is disabled when the vehicle 105 is in a road area 205.

The training mode records and stores, e.g., in a memory of the vehicle computer 110, a travel path P of the vehicle 105 through a parking area 200. Specifically, in the training mode, a user can operate the vehicle 105 along a travel path P through the parking area 200, and the vehicle computer 110 is programmed to actuate one or more sensors 115 to record the travel path P of the vehicle 105. The vehicle computer 110 can then operate the vehicle 105 in the parking area 200 based on the stored travel path P, as discussed further below.

When the training mode is in the enabled state, the vehicle computer 110 enables user selection of the training mode. For example, the vehicle computer 110 may actuate the HMI 118 to detect a first user input selecting the training mode. For example, the HMI 118 may be programmed to display a virtual button on a touchscreen display that the user can select to select the training mode. In this situation, the HMI 118 may activate sensors 115 that can detect the user selecting the virtual button to select the training mode. As another example, the HMI 118 may be programmed to provide a virtual button or the like that is non-selectable when the training mode is in the disabled state, and selectable via the touchscreen display when the training mode is in the enabled state. Upon detecting the first user input, the HMI 118 can then provide the first user input to the vehicle computer 110, and the vehicle computer 110 can select the training mode based on the first user input.

When the training mode is in the disabled state, the vehicle computer 110 may actuate the HMI 118 to disable detection of the first user input. In this manner, the vehicle computer 110 can prevent the user from selecting the training mode, i.e., when the vehicle 105 is on a road area 205. For example, the HMI 118 may be programmed to remove a virtual button from the touchscreen display. As another example, the HMI 118 may be programmed to make the virtual button non-selectable.

When the training mode is selected, the vehicle computer 110 can output a message, e.g., via the HMI 118, instructing the user to operate the vehicle 105 along a travel path P through the parking area 200. While the user operates the vehicle 105 in the training mode, the vehicle computer 110 can record the travel path P. For example, the vehicle computer 110 can receive location data for the vehicle 105 at predetermined distance intervals, e.g., every 10 feet, 10 meters, etc. The vehicle computer 110 can generate and store the travel path P based on such successive vehicle 105 locations. For example, the vehicle computer 110 can determine geo-coordinates specified by the location data of the vehicle 105 after each distance interval. The vehicle computer 110 can determine that the vehicle 105 has moved the predetermined distance interval based on sensor 115 data. For example, the vehicle computer 110 can count a number of wheel rotations detected by a wheel sensor 115 and can then determine a distance traveled based on a diameter of the wheel, e.g., stored in a memory of the vehicle computer 110. The vehicle computer 110 can then store the determined geo-coordinates, e.g., in a memory of the vehicle computer 110.

Additionally, the vehicle computer 110 can identify a plurality of segments S along the travel path P based on successive vehicle 105 locations. That is, each segment S may extend from one vehicle 105 location to a successive vehicle location 105, i.e., the predetermined distance interval. Each segment S can include an identifier, e.g., a numerical value, an alphanumeric string, etc., identifying the respective segment S. The vehicle computer 110 can generate and assign an identifier to a corresponding segment S. For example, the vehicle computer 110 can maintain a counter. Upon detecting a segment S, i.e., upon determining that the vehicle 105 has traveled the predetermined distance interval from a previous location, the vehicle computer 110 can increment the counter and assign a counter value to the segment S.

While recording the travel path P, the vehicle computer 110 can collect operation data of one or more components 125 from one or more sensors 115. Specifically, the vehicle computer 110 collects operation data for each of the plurality of segments S of the travel path P. In this context, “operation data” are data describing operation of the components 125. The operation data can include, e.g., speed data, acceleration data, braking data, steering angle data, etc. That is, as the user actuates components 125 along the travel path P, the operation data describe how the vehicle 105 operates along the travel path P.

The vehicle computer 110 can determine a risk level for each of the plurality of segments S. As used herein, a “risk level” is a measure that the vehicle computer 110 can use to determine operating parameters for the vehicle 105 along a segment S, and that indicates a likelihood of the vehicle 105 impacting an object while operating along the segment S. The risk level may be specified as a text string, e.g., “high”, “medium”, or “low”. As another example, the risk level may be specified as a number, e.g., an integer on a scale from 1 to 3, inclusive. In this example, a risk level of 3 represents a higher likelihood that the vehicle 105 will impact an object along the segment S than a risk level of 2 or 1, and a risk level of 1 represents a lower likelihood that the vehicle 105 will impact an object along the segment S than a risk level of 2.

The vehicle computer 110 can, for example, determine a risk level for a segment S based on operation data for the segment S. For example, the vehicle computer 110 can analyze operation data for the segment to determine a number of collision avoidance maneuvers performed within the segment S. As used herein, a “collision avoidance maneuver” is an actuation of a vehicle component 125 to avoid impacting an object along the travel path P. The vehicle computer 110 can record a number of collision avoidance maneuvers performed along the segment S. That is, upon determining that a collision avoidance maneuver is performed along the segment S, the vehicle computer 110 can increment by one a counter, typically initialized to zero, of instances of performed collision avoidance maneuvers. For example, the vehicle computer 110 can store the number of collision avoidance maneuvers performed along the segment S, e.g., in a memory of the vehicle computer 110.

To determine the risk level, the vehicle computer 110 can compare the number of collision avoidance maneuvers performed in the segment S to a first threshold. The first threshold specifies a maximum number of collision avoidance maneuvers performed along the segment S, e.g., one, below which the vehicle computer 110 can determine that a risk level of the segment is “low” (or 1), assuming for the current example, that a risk level can be 1, 2, or 3, or low, medium or high. The first threshold may be specified by a vehicle 105 and/or component manufacturer based on, e.g., empirical testing to determine a number of collision avoidance maneuvers performed in a segment S below which a vehicle impact would not likely occur. The first threshold may be stored, e.g., in a memory of the vehicle computer 110. When the number of collision avoidance maneuvers is less than the first threshold, the vehicle computer 110 determines that the risk level is “low” (or 1).

When the number of collision avoidance maneuvers is greater than or equal to the first threshold, the vehicle computer 110 can compare the number of collision avoidance maneuvers to a second threshold. That is, the second threshold is greater than the first threshold. The second threshold specifies a maximum number of collision avoidance maneuvers performed along the segment S, e.g., two, below which the vehicle computer 110 can determine that a risk level of the segment is “medium” (or 2). The second threshold may be specified by a vehicle 105 and/or component manufacturer based on, e.g., empirical testing to determine a number of collision avoidance maneuvers performed in a segment S above which a vehicle impact would likely occur. The second threshold may be stored, e.g., in a memory of the vehicle computer 110. When the number of collision avoidance maneuvers is less than the second threshold, the vehicle computer 110 determines that the risk level is “medium” (or 2). When the number of collision avoidance maneuvers is greater than or equal to the second threshold, the vehicle computer 110 determines that the risk level is “high” (or 3).

The vehicle computer 110 can determine a collision avoidance maneuver based on sensor 115 data. For example, the vehicle computer 110 can detect actuation of a brake component 125 via a brake sensor 115. A brake sensor 115 can be any suitable type of sensor to measure movement of a brake pedal, including how much pressure is applied to the brake pedal. The brake sensor 115 may output a signal representing as much to the vehicle computer 110. As one example, the vehicle computer 110 can count actuation of the brake component 125 by at least a specified pressure that indicates emergency braking as a collision avoidance maneuver. The specified pressure may stored, e.g., in a memory of the vehicle computer 110.

As another example, the vehicle computer 110 can detect actuation of a steering component 125 via a steering sensor 115. A steering sensor 115 can be any suitable type of sensor to measure movement of a steering wheel, including an angular velocity of the steering wheel. The steering sensor 115 may output a signal representing as much to the vehicle computer 110. As one example, the vehicle computer 110 can count actuation of the steering component 125 by at least a specified angular velocity that indicates emergency steering as a collision avoidance maneuver. The specified angular velocity may stored, e.g., in a memory of the vehicle computer 110.

Additionally, or alternatively, the vehicle computer 110 can determine the risk level for a segment S based on a user input specifying the risk level for the segment S. For example, the vehicle computer 110 may actuate the HMI 118 to detect the user input specifying the risk level for the segment S. For example, the HMI 118 may be programmed to display virtual buttons on a touchscreen display that the user can select to specify the risk level for the segment S. In this situation, the HMI 118 may activate sensors 115 that can detect the user selecting the virtual button to specify the risk level for the segment S. Upon detecting the user input, the HMI 118 can then provide the user input to the vehicle computer 110, and the vehicle computer 110 can determine the risk level for the segment S based on the user input.

The vehicle computer 110 can determine vehicle operating parameters for each of the plurality of segments S. An operating parameter herein is an expected value of a measurement of a physical characteristic of a vehicle 105 or an environment around that vehicle 105 while the vehicle 105 is operating in a respective segment S. A variety of operating parameters may be determined for a vehicle 105 operating along each segment S. A non-limiting list of operating parameters includes a speed of the vehicle 105, a following distance between vehicles, a stopping location within a segment S, an acceleration rate of the vehicle 105, etc. For example, the vehicle computer 110 can determine operating parameters for a segment S based on the operation data obtained while the vehicle 105 operates along the segment S in the training mode. In such an example, operating parameters for the segment S may correspond to the operation data of the segment S. For example, the vehicle computer 110 can determine a speed to operate the vehicle 105 along the segment S based on speed data included in the operation data. As another example, the vehicle computer 110 can determine a stopping location within the segment S based on brake data included in the operation data.

Alternatively, the vehicle computer 110 can determine operating parameters for each segment S based on a risk level for the respective segment S. For example, the vehicle computer 110 may maintain a look-up table, or the like, that associates various operating parameters with corresponding risk levels. The vehicle computer 110 can, for example, access the look-up table and determine the operating parameters for a segment S based on a stored risk level matching a determined risk level for the segment S. The look-up table may be stored, e.g., in a memory of the vehicle computer 110. An example look-up table is set forth below in Table 1.

Additionally, the vehicle computer 110 can actuate one or more vehicle components 125 to output an alert that the vehicle 105 is moving along the travel path P based on the risk level for the segment S (see Table 1). For example, the vehicle computer 110 can actuate a horn, exterior lights (e.g., to flash headlamps, to activate backup lights, etc.), etc. to output the alert. The alert can notify an object to the travel path P of the vehicle 105 and indicate that the object is obstructing the travel path P.

TABLE 1

| Risk Level | Criteria | Operating Parameters | |
|---|---|---|---|
| High (or 3) | Maximum speed | 5 miles per | |
| | | hour (mph) | |
| | Minimum following | 30 | feet |
| | distance | | |
| | Alert | Actuate horn and | |
| | | exterior lights | |
| Medium (or 2) | Maximum speed | 10 | mph |
| | Minimum following | 25 | feet |
| | distance | | |
| | Alert | Actuate exterior | |
| | | lights | |
| Low (or 1) | Maximum speed | 15 | mph |
| | Minimum following | 20 | feet |
| | distance | | |

| | |
|---|---|
| Alert | None |

The vehicle computer 110 may be programmed to stop recording the travel path P upon detecting a second user input. For example, the vehicle computer 110 may actuate the HMI 118 to detect the second user input deselecting the training mode. For example, the HMI 118 may be programmed to display a virtual button on a touchscreen display that the user can select to deselect the training mode. As another example, the HMI 118 may be programmed to provide a virtual button or the like that is non-selectable when the training mode is in the disabled state, and selectable via the touchscreen display when the training mode is in the enabled state. In other words, the HMI 118 may activate sensors 115 that can detect the user selecting the virtual button to deselect the training mode. Upon detecting the second user input, the HMI 118 can then provide the second user input to the vehicle computer 110, and the vehicle computer 110 can deselect the training mode and stop recording the travel path P based on the second user input.

The vehicle computer 110 can be programmed to update the map of the area 200, e.g., stored in the memory of the vehicle computer 110, received from the remote server computer 140, etc., to specify the travel path P, including the segments S thereof and the corresponding risk levels. For example, the vehicle computer 110 can update the map based on the recorded travel path P. Additionally, the vehicle computer 110 can update the map to specify segments S of the travel path P and a corresponding risk level for each segment S. The vehicle computer 110 can store the updated map, e.g., in a memory of the vehicle computer 110. Additionally, or alternatively, the vehicle computer 110 can provide the updated map to the remote server computer 140.

In addition to transitioning the training mode as discussed above, the vehicle computer 110 can be programmed to transition a valet mode between a disabled state and an enabled state based on the location of the vehicle 105, e.g., in substantially the same manner as discussed above in regards to the training mode. The valet mode can include operation of the vehicle 105 through the parking area 200. For example, the vehicle computer 110 can actuate one or more vehicle components 125 to move the vehicle 105 along the stored travel path P in the parking area 200, e.g., to search for available sub-areas 210, to pick up a user at a specified location, etc. Specifically, the vehicle computer 110 can operate the vehicle 105 along the stored travel path P based on operating parameters for each segment S of the stored travel path P. As discussed above, the vehicle computer 110 can determine the operating parameters for each segment S based on operation data and/or a risk level for the respective segment S. The vehicle computer 110 can operate the vehicle 105 in the valet mode, i.e., along the stored travel path P, based on receiving a request, e.g., from a remote server computer 140, a user device (e.g., a smartphone, a tablet, a personal digital assistant, a smart watch, a laptop, etc.), etc.

The vehicle computer 110 can, for example, access the stored travel path P from a memory of the vehicle computer 110. That is, the vehicle computer 110 can operate the vehicle 105 to follow the recorded travel path P specified by the user during operation of the vehicle 105 in the training mode. As another example, the vehicle computer 110 can determine the travel path P based on a map. In such an example, the vehicle computer 110 can receive a map of the parking area, e.g., from a remote server computer 140. The map can, for example, specify the travel path P, including the plurality of segments S and corresponding risk levels for the segments, based on aggregated data (as discussed below).

While operating the vehicle 105 in the valet mode, along the stored travel path P, the vehicle computer 110 can receive sensor 115 data, e.g., image data, of the environment around the vehicle 105. The image data can include one or more objects 215, 220 around the vehicle 105. For example, the vehicle computer 110 can be programmed to classify and/or identify object(s) 215, 220 based on sensor 115 data. For example, object classification techniques can be used, e.g., in the vehicle computer 110 based on lidar sensor 115 data, camera sensor 115 data, etc., to classify a detected object 215, 220 as mobile or stationary, i.e., non-movable. Additionally, or alternatively, object identification techniques can be used, e.g., in the vehicle computer 110 based on lidar sensor 115 data, camera sensor 115 data, etc., to identify a type of object 215, 220, e.g., a vehicle, a pedestrian, a drone, etc., as well as physical features of objects. Non-limiting examples of objects 215, 220 include a pedestrian, another vehicle, a bicycle, a shopping cart, a pole, etc.

Various techniques such as are known may be used to interpret sensor 115 data and/or to classify objects 215, 220 based on sensor 115 data. For example, camera and/or lidar image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input vehicle sensor 115 data, e.g., an image, and then provide as output, for each of one or more respective regions of interest in the image, an identification and/or a classification (i.e., mobile or stationary) of one or more objects 215, 220 or an indication that no object 215, 220 is present in the respective region of interest. Further, a coordinate system (e.g., polar or cartesian) applied to an area proximate to the vehicle 105 can be applied to specify locations and/ or areas (e.g., according to the vehicle 105 coordinate system, translated to global latitude and longitude geo-coordinates, etc.) of objects 215, 220 identified from sensor 115 data. Yet further, the vehicle computer 110 could employ various techniques for fusing (i.e., incorporating into a common coordinate system or frame of reference) data from different sensors 115 and/or types of sensors 115, e.g., lidar, radar, and/or optical camera data.

While the vehicle 105 is at a first location in a segment S of the stored travel path P, the vehicle computer 110 can define a blind zone for the vehicle 105 at the first location based on sensor 115 data, e.g., fields of view of the sensors 115. For example, sensors 115 may be mounted to a rear, front, and/or a side of the vehicle 105 exterior. Respective fields of view of each of one or more sensors 115 may partially overlap. In the present context, a blind zone of a sensor 115 is an area or, more typically, a three-dimensional space, i.e., a volume, outside a field of view of the sensor 115, i.e., an area or volume from which a sensor 115 cannot obtain data. A blind zone for a vehicle 105 can exist when sensors 115 of the vehicle 115 collective cannot provide data to detect objects and environmental features within an area or volume. A shape or boundaries of a blind zone is typically defined by a body of the vehicle 105 and features and objects in an environment that occupy, surround, and/or abut the blind zone. When the vehicle 105 is at the first location, a stationary object 215, e.g., a parked vehicle, may define a portion of the blind zone. The fields of view of the sensors 115 may be determined empirically, e.g., based on fields of view required to perform one or more vehicle 105 functions. The vehicle computer 110 may store the fields of view of each of the sensors 115, e.g., in a memory.

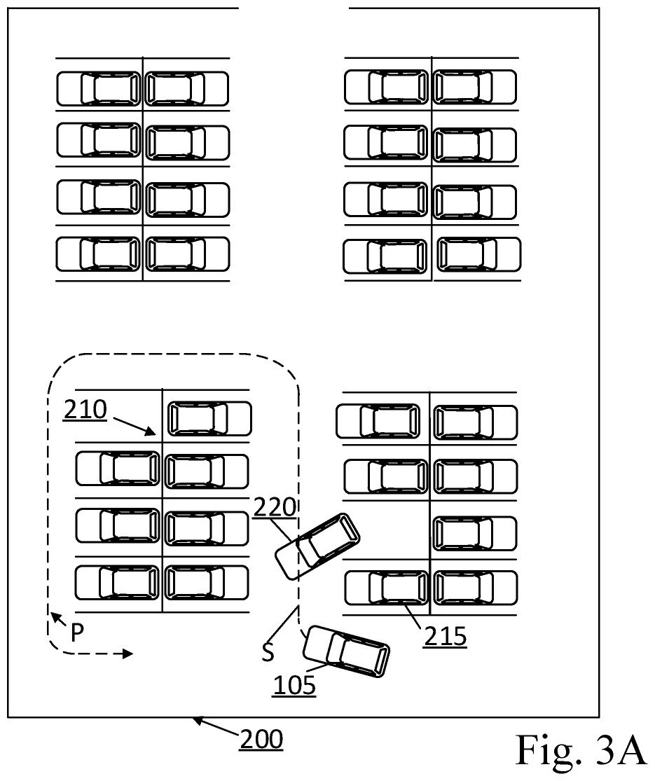

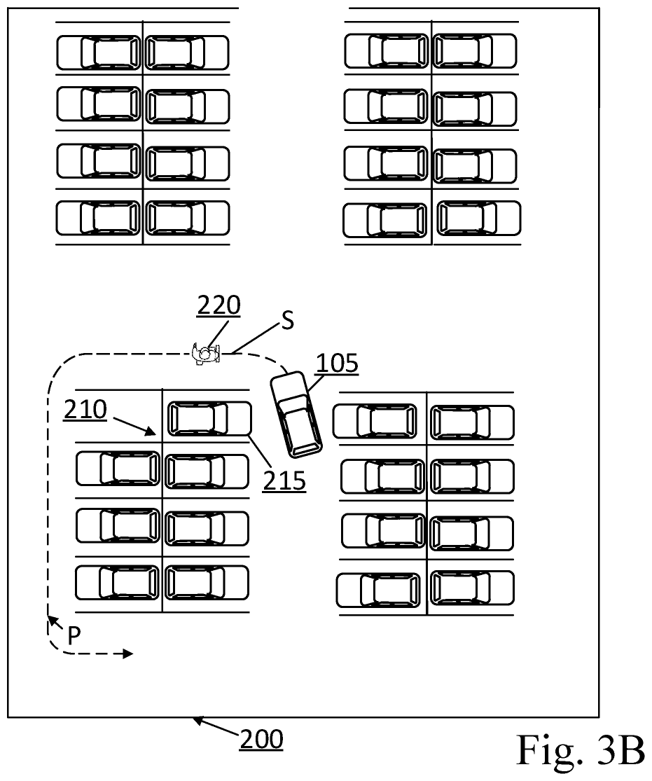

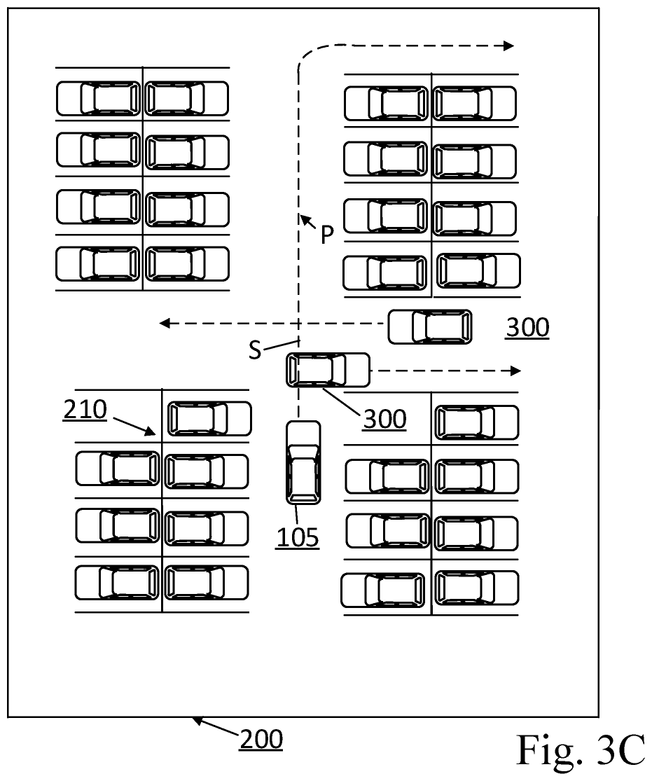

While the vehicle 105 is operating along the travel path P to a second location, the vehicle computer 110 can receive sensor 115 data, e.g., image data, of the blind zone for the vehicle 105 at the second location. The second location can be in a same segment S as the first location. Alternatively, the second location can be in a different, e.g., next, segment S than the first location. The image data can include a mobile object 220 that is in the blind zone and was previously undetected. The vehicle computer 110 can the determine whether the blind zone is occupied or unoccupied based on sensor 115 data indicating a presence or absence of a mobile object 220 in the blind zone. For example, the vehicle computer 110 can identify a mobile object 220 in the blind zone based on output from the classifier, as discussed above. As one example, the mobile object 220 may be a pedestrian (see FIG. 3B). As another example, the mobile object 220 may be a vehicle (see FIG. 3A).

Upon determining that the blind zone is unoccupied, the vehicle computer 110 can maintain vehicle 105 operation along the segment S. That is, the vehicle computer 110 can operate the vehicle 105 based on the current risk level for the segment S. In other words, the vehicle computer 110 can actuate one or more vehicle components 125 to move the vehicle 105 along the segment S while satisfying the current operating parameters for the segment S.

Upon identifying a mobile object 220 in the blind zone, the vehicle computer 110 can determine to perform a collision avoidance maneuver. For example, the vehicle computer 110 can determine to perform a collision avoidance maneuver based on detecting the mobile object 220 is within a distance threshold (as discussed below) of the vehicle 105 and intersects the stored travel path P. If the vehicle computer 110 detects that the mobile object 220 is within the distance threshold of the vehicle 105 and intersects the segment S, then the vehicle computer 110 can actuate one or more vehicle components 125, e.g., a steering component, a braking component, etc., to avoid impacting the mobile object 220, i.e., to perform a collision avoidance maneuver. If the vehicle computer 110 detects the mobile object 220 is outside of the distance threshold of the vehicle 105 or does not intersect the segment S, then the vehicle computer 110 can actuate one or more vehicle components 125 to maintain vehicle operation along the segment S, e.g., based on the operating parameters for the first segment S.

The vehicle computer 110 can determine that the mobile object 220 intersects the segment S based on sensor 115 data. For example, the vehicle computer 110 can compare a location of the mobile object 220, e.g., obtained via image data, to the segment S. The vehicle computer 110 can, for example, determine that the mobile object 220 intersects the segment S based on determining that the segment S extends through the location of the mobile object 220. Alternatively, vehicle computer 110 can determine that the mobile object 220 intersects the segment S based on the location of the mobile object 220 being within a specified distance of the segment S. The specified distance is a minimum distance between the segment S and the location of a mobile object 220 within which the vehicle 105, while maintaining operation along the stored travel path P, may impact the mobile object 220. The specified distance may be determined empirically, e.g., based on a width of the vehicle 105 and lateral movement of the vehicle 105 relative to the stored travel path P while the vehicle 105 operates along the stored travel path P. The specified distance may be stored, e.g., in a memory of the vehicle computer 110.

Additionally, the vehicle computer 110 can be programmed to predict whether a future location of the mobile object 220 will intersect the segment S. The vehicle computer 110 can predict the future location of the mobile object 220 based on sensor 115 data. The future location of the mobile object 220 is defined at least in part by a predicted path of the mobile object 220. For example, the vehicle computer 110 can predict a path of the mobile object 220 based on identifying a direction of movement of the mobile object 220 via sensor 115 data, e.g., sequential frames of image data. The vehicle computer 110 can then compare the predicted path of the mobile object 220 to the segment S. The vehicle computer 110 can, for example, predict that the mobile object 220 will intersect the segment S based on determining that the segment S extends through the future location. Alternatively, the vehicle computer 110 can, for example, predict that the mobile object 220 will intersect the segment S based on determining that the future location of the mobile object 220 is within the specified distance of the segment S.

Further, the vehicle computer 110 can determine a distance between the vehicle 105 and the mobile object 220 based on sensor 115 data. For example, a lidar sensor 115, which is similar to a radar sensor 115, using laser light transmissions (instead of radio transmissions) to obtain reflected light pulses from objects 215, 220. The reflected light pulses can be measured to determine object distances. For example, a lidar sensor 115 can emit a light beam and receive a reflected light beam reflected off an object 215, 220. The vehicle computer 110 can measure a time elapsed from emitting the light beam to receiving the reflected light beam. Based on the time elapsed and the speed of light, the vehicle computer 110 can determine the distance between the vehicle 105 and the object 215, 220. Data from the lidar sensor 115 can be provided to generate a three-dimensional representation of detected objects, sometimes referred to as a point cloud.

The vehicle computer 110 can then compare the distance to a distance threshold, e.g., stored in a memory of the vehicle computer 110. The distance threshold specifies a distance between the vehicle 105 and a mobile object 220 within which the vehicle computer 110 determines to perform a collision avoidance maneuver. The distance threshold can be determined based on, e.g., empirical testing to determine a minimum distance at which the vehicle computer 110 can adjust operation of the vehicle 105, e.g., by stopping, turning, etc., to avoid impacting the mobile object 220 (e.g., based on a speed of the vehicle 105).

To perform a collision avoidance maneuver, the vehicle computer 110 actuates one or more vehicle components 125 to avoid impacting the mobile object 220 along the segment S. For example, the vehicle computer 110 can actuate a braking component to stop the vehicle 105. Additionally, or alternatively, the vehicle computer 110 can actuate a steering component to move the vehicle 105 off the stored travel path P, e.g., around the mobile object 220.

Upon performing a collision avoidance maneuver, the vehicle computer 110 identifies the segment S of the stored travel path P. For example, the vehicle computer 110 may receive a current location of the vehicle 105, e.g., from a sensor 115, a navigation system, a remote server computer 140, etc. The vehicle computer 110 can then compare the current location to the stored travel path P. The vehicle computer 110 can identify the segment S, e.g., via a respective identifier, based on determining that the current location is between vehicle 105 locations defining the segment S (as discussed above in regard to the training mode). The vehicle computer 110 can then increase the count of the number of collision avoidance maneuvers for the segment S.

The vehicle computer 110 can update, e.g., increase, the risk level of the segment S based on performing the collision avoidance maneuver along the segment S. For example, the vehicle computer 110 can incrementally increase the risk level of the segment S. As another example, the vehicle computer 110 can increase the count of the number of collision avoidance maneuvers performed along the segment S and compare that count to the first and second thresholds, as discussed above. In the case that the vehicle 105 impacts the mobile object 220, the vehicle computer 110 can increase the risk level for the segment S to a highest risk level, e.g., “high” (or 3).

Additionally, or alternatively, the vehicle computer 110 can update the risk level of the segment S based on determining that the segment S extends through an intersection of two or more lanes (see FIG. 3C). As used herein, an “intersection” is an area at which two or more lanes cross each other. A lane is a specified area of an aisle for vehicle travel. An aisle in the present context is an area of ground surface in the parking area 200 that includes any surface provided for land vehicle travel. A plurality of sub-areas 210 may be positioned along a length of an aisle. A lane of an aisle is an area defined along a length of an aisle, typically having a width to accommodate only one vehicle, i.e., such that multiple vehicles can travel in a lane one in front of the other, but not abreast of, i.e., laterally adjacent, one another.

The vehicle computer 110 can, for example, determine that the segment S extends through an intersection of two or more lanes based on map data. In such an example, the vehicle computer 110 can identify the segment S based on the vehicle 105 locations defining the segment S (as discussed above in regards to the training mode). The vehicle computer 110 can then compare the locations defining the segment S to the map data. The vehicle computer 110 can increase the risk level of the segment S based on determining that the locations defining the segment S are on opposite sides of an intersection.

As another example, the vehicle computer 110 can determine that the segment S extends through an intersection of two or more lanes based on sensor 115 data. In such an example, the vehicle computer 110 can detect, e.g., via successive frames of image data, other vehicle(s) 300 moving substantially orthogonally across the segment S (see FIG. 3C). Alternatively, the vehicle computer 110 can detect, e.g., via image data, and identify, e.g., via image processing techniques, one or more signs along the segment S that indicates an intersection, e.g., a stop sign, a yield sign, etc.

Upon updating the risk level for the segment S, the vehicle computer 110 can update vehicle operating parameters for the segment S. For example, the vehicle computer 110 can access a look-up table or the like that associates various operating parameters with corresponding risk levels, as discussed above. In this example, the vehicle computer 110 can update the vehicle operating parameters to correspond to the stored vehicle operating parameters associated with the updated risk level. As another example, the vehicle computer 110 can determine the updated vehicle operating parameters based on the current vehicle operating parameters. For example, an updated vehicle speed may be a predetermined percentage, e.g., 75%, of a current vehicle speed, and/or an updated following distance may be a predetermined percentage, e.g., 125%, of a current following distance.

After performing the collision avoidance maneuver, the vehicle computer 110 can determine that the mobile object 220 does not intersect the segment S based on sensor 115 data. For example, the vehicle computer 110 can compare a subsequent location of the mobile object 220, e.g., obtained via image data, to the segment S. The vehicle computer 110 can, for example, determine that the mobile object 220 does not intersect the segment S based on determining that the subsequent location of the mobile object 220 is outside of the specified distance of the segment S. In the case that the mobile object 220 intersects the segment S, the vehicle computer 110 can maintain a stopped position of the vehicle 105 and/or perform subsequent collision avoidance maneuvers. In the case that the mobile object 220 does not intersect the segment S, e.g., has moved, the vehicle computer 110 can continue to operate the vehicle 105 along the stored travel path P. That is, the vehicle computer 110 can actuate one or more vehicle components 125 to move the vehicle 105 along the stored travel path P. The vehicle computer 110 can then operate the vehicle 105 along the segment S at a future time, e.g., a next day.

At the future time, the vehicle computer 110 operates the vehicle 105 along the segment S based on the updated vehicle operating parameters for the segment S. The vehicle computer 110 can be programmed to detect subsequent mobile objects 220 intersecting the segment S within the distance threshold of the vehicle 105, e.g., in substantially the same manner as discussed above in regards to detecting the mobile object 220. If the vehicle computer 110 detects a subsequent mobile object 220 intersecting the segment S within the distance threshold of the vehicle 105, then the vehicle computer 110 can perform a collision avoidance maneuver, as discussed above. The vehicle computer 110 can then increase the risk level of the segment S, as discussed above. If the vehicle computer 110 does not detect a subsequent mobile object 220 intersecting the segment S within the distance threshold of the vehicle 105, then the vehicle computer 110 maintains vehicle operation along the segment S based on the updated vehicle operating parameters, i.e., does not perform a collision avoidance maneuver.

The vehicle computer 110 may be programmed to reset the risk level of the segment S. For example, upon increasing the risk level of the segment S, the vehicle computer 110 can initiate a timer. The timer may have a predetermined duration, e.g., 2 days, 5 days, 10 days, etc. The vehicle computer 110 can reset the risk level of the segment S based on not performing any collision avoidance maneuvers, i.e., not actuating a vehicle component 125 to avoid impacting a subsequent mobile object 220, in the segment S prior to expiration of the timer. That is, if the vehicle computer 110 does not detect a subsequent mobile object 220 intersecting the segment S within the distance threshold of the vehicle 105 prior to expiration of the timer, then the vehicle computer 110 can reset, i.e., decrease, the risk level of the segment S. Additionally, or alternatively, if the vehicle 105 does not impact a subsequent mobile object 220 along the segment S prior to expiration of the timer, then the vehicle computer 110 can reset, i.e., decrease, the risk level of the segment S. The vehicle computer 110 can, for example, reset the risk level to a lowest risk level, e.g., “low” (or 1). As another example, the vehicle computer 110 can incrementally decrease the risk level of the segment S.

The vehicle computer 110 can be programmed to update the map of the area 200, e.g., stored in the memory of the vehicle computer 110, received from the remote server computer 140, etc., to specify the updated (or reset) risk level for the segment S. The vehicle computer 110 can store the updated map, e.g., in a memory of the vehicle computer 110. Additionally, or alternatively, the vehicle computer 110 can provide the updated map to the remote server computer 140.

The remote server computer 140 may be programmed to update the map of the area 200, e.g., stored in the second memory, based on aggregated data. Aggregated data means data from a plurality of vehicle computers that provide messages and then combining (e.g., by averaging and/or using some other statistical measure) the results. That is, the remote server computer 140 may be programmed to receive messages from a plurality of vehicle computers indicating an updated (or reset) risk level for a segment S of a travel path P based on vehicle data of a plurality of vehicles. Based on the aggregated data indicating the updated (or reset) risk level for the segment S (e.g., an average number of messages, a percentage of messages, etc., indicating the updated (or reset) risk level being above a threshold), and taking advantage of the fact that messages from different vehicles are provided independently of one another, the remote server computer 140 can update the map to specify the updated (or reset) risk level for the segment S of the travel path P based on the vehicle data. The remote server computer 140 can then transmit the map to a plurality of vehicles, including the vehicle 105, e.g., via the network 135.

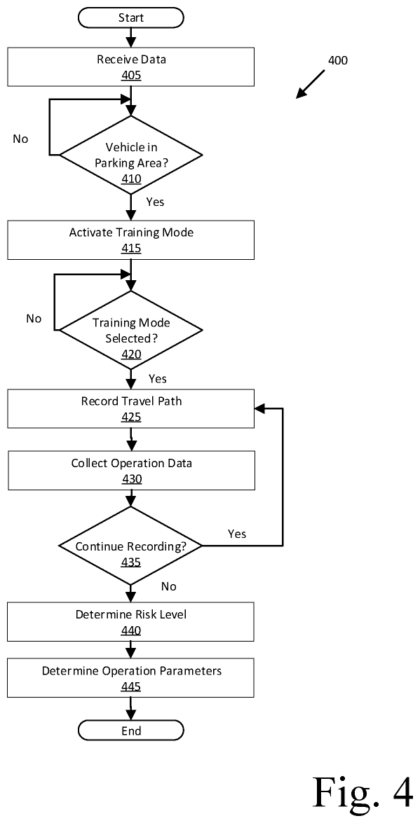

FIG. 4 is a diagram of an example process 400 for determining a travel path P for a vehicle 105. The process 400 begins in a block 405. The process 400 can be carried out by a vehicle computer 110 included in the vehicle 105 executing program instructions stored in a memory thereof.

In the block 405, the vehicle computer 110 receives data from one or more sensors 115, e.g., via a vehicle network, from a remote server computer 140, e.g., via a network 135, and/or from a computer in another vehicle, e.g., via V2V communications. For example, the vehicle computer 110 can receive location data, e.g., geo-coordinates, of the vehicle 105, e.g., from a sensor 115, a navigation system, etc. Additionally, the vehicle computer 110 can receive image data, e.g., from one or more image sensors 115. The image data may include data about the environment around the vehicle 105, e.g., the parking area 200, a sub-area 210, one or more objects 215, 220. The process 400 continues in a block 410.

In the block 410, the vehicle computer 110 determines whether the vehicle 105 is in a parking area 200 or a road area (not shown) based on map data and/or the received data, e.g., image data and/or location data. For example, the vehicle computer 110 can compare the location of the vehicle 105 to the location of the parking area 200 to determine whether the vehicle 105 is within a geo-fence of the parking area 200, as discussed above. As another example, the vehicle computer 110 can compare the location of the vehicle 105 to map data to determine whether the vehicle 105 is in the parking area 200, as discussed above. If the vehicle computer 110 determines that the vehicle 105 is in the parking area 200, then the process 400 continues in a block 415. If the vehicle computer 110 determines that the vehicle 105 is not in a parking area 200, i.e., is in a road area, then the process 400 remains in the block 410.

In the block 415, the vehicle computer 110 enables the training mode. For example, upon determining that the vehicle 105 has moved from a road area to a parking area 200, the vehicle computer 110 enables the training mode from the disabled state to an enabled state. Additionally, the vehicle computer 110 can maintain the training mode in the enabled state upon determining that the vehicle 105 remains in the parking area 200. In the enabled state, the vehicle computer 110 enables user selection of the training mode. The process 400 continues in a block 420.

In the block 420, the vehicle computer 110 determines whether the training mode is selected. For example, in the enabled state, the vehicle computer 110 may actuate an HMI 118 to detect a first user input selecting the training mode, as discussed above. Upon detecting the first user input, the HMI 118 can then provide the first user input to the vehicle computer 110, and the vehicle computer 110 can select the training mode based on the first user input. If the vehicle computer 110 receives the first user input selecting the training mode, then the process 400 continues in a block 425. Otherwise, the process 400 remains in the block 420.

In the block 425, the vehicle computer 110 records a travel path P of the vehicle 105. While the user is operating the vehicle 105 in the training mode, the vehicle computer 110 can, for example, receive location data for the vehicle 105 at predetermined distance intervals, e.g., every 10 feet, 10 meters, etc. The vehicle computer 110 can then generate the travel path P, including a plurality of segments S, based on successive vehicle 105 locations, as discussed above. The process 400 continues in a block 430.

In the block 430, the vehicle computer 110 collects operation data of one or more components 125 from one or more sensors 115. Specifically, the vehicle computer 110 collects operation data for each of a plurality of segments S of the travel path P. As set forth above, the operation data describe how the vehicle 105 operates along the travel path P. The process 400 continues in a block 435.

In the block 435, the vehicle computer 110 determines whether to continue recording the travel path P. For example, the vehicle computer 110 can stop recording the travel path P based on receiving a second user input deselecting the training mode, e.g., via the HMI 118, as discussed above. If the vehicle computer 110 receives the second user input, then the vehicle computer 110 determines to stop recording the travel path P. If the vehicle computer 110 fails to receive the second user input, then the vehicle computer 110 determines to continue recording the travel path P. If the vehicle computer 110 determines to stop recording the travel path P, then the process 400 continues in a block 440. Otherwise, the process 400 returns to the block 425.

In the block 440, the vehicle computer 110 determines a risk level for each of a plurality of segments S of the travel path P. As set forth above, the risk level for each segment S indicates a likelihood of the vehicle 105 impacting an object while operating along the segment S. The vehicle computer 110 can, for example, determine a risk level for a segment S based on operation data for the segment S. For example, the vehicle computer 110 can analyze operation data for the segment to determine a number of collision avoidance maneuvers performed within the segment S, i.e., actuations of a vehicle component 125, e.g., a steering component, a braking component, etc., to avoid impacting a mobile object 220 along the segment S, as discussed above. The vehicle computer 110 can then compare the number of collision avoidance maneuvers performed in the segment S to a first threshold and/or a second threshold to determine the risk level, as discussed above.

Additionally, or alternatively, the vehicle computer 110 can determine the risk level for a segment S based on a user input specifying the risk level for the segment S. For example, in the enabled state, the vehicle computer 110 may actuate an HMI 118 to detect the user input specifying the risk level for the segment S, as discussed above. Upon detecting the user input, the HMI 118 can then provide the user input to the vehicle computer 110, and the vehicle computer 110 can determine the risk level for the segment S based on the user input.

Additionally, the vehicle computer 110 can update a map of the parking area 200. For example, the vehicle computer 110 can update the map of the parking area 200 to specify the travel path P, including the plurality of segments S and the corresponding risk levels, as discussed above. The vehicle computer 110 can then provide the updated map to the remote server computer 140, which can update the map further based on aggregated data, as discussed above. The process 400 continues in a block 445.

In the block 445, the vehicle computer 110 determines operating parameters for each of the segments S. For example, the vehicle computer 110 can determine operating parameters for a segment S based on the operation data obtained while the vehicle 105 operates along the segment S in the training mode, as discussed above. Alternatively, the vehicle computer 110 can determine operating parameters for each segment S based on a risk level for the respective segment S, as discussed above. The process 400 ends following the block 445.

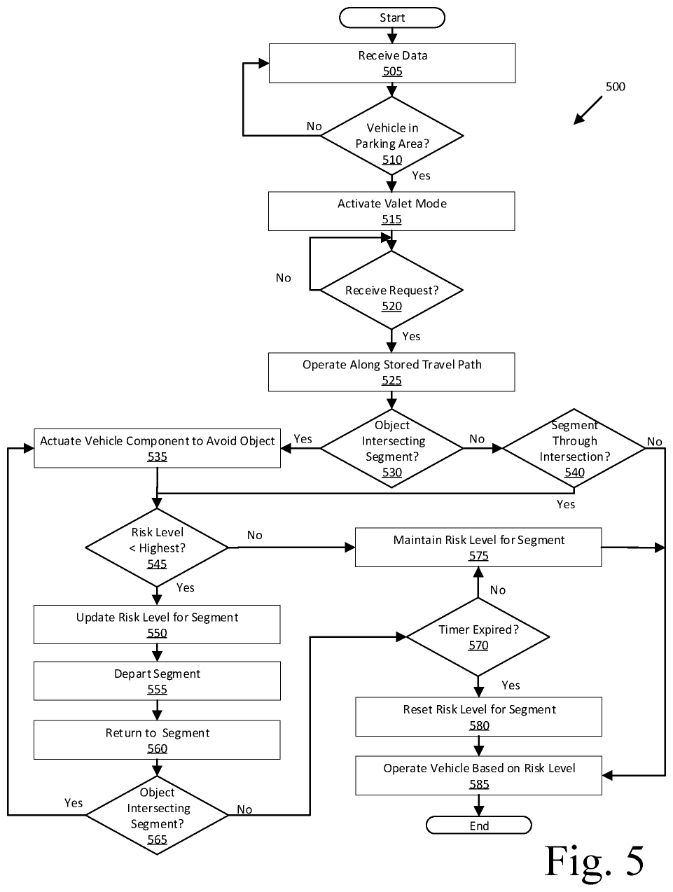

FIG. 5 is a diagram of an example process 500 for updating a risk level for a segment of the travel path P. The process 500 begins in a block 505. The process 500 can be carried out by a vehicle computer 110 included in the vehicle 105 executing program instructions stored in a memory thereof.

In the block 505, the vehicle computer 110 receives data from one or more sensors 115, e.g., via a vehicle network, from a remote server computer 140, e.g., via a network 135, and/or from a computer in another vehicle, e.g., via V2V communications. The block 505 is substantially the same as the block 405 of process 400 and therefore will not be described further to avoid redundancy. The process 500 continues in a block 510.

In the block 510, the vehicle computer 110 determines whether the vehicle 105 is in a parking area 200 or a road area (not shown) based on map data and/or the received data, e.g., image data and/or location data. The block 510 is substantially the same as the block 410 of process 400 and therefore will not be described further to avoid redundancy. If the vehicle computer 110 determines that the vehicle 105 is in the parking area 200, then the process 500 continues in a block 515. If the vehicle computer 110 determines that the vehicle 105 is not in a parking area 200, i.e., is in a road area, then the process 500 remains in the block 510.

In the block 515, the vehicle computer 110 enables the valet mode. For example, upon determining that the vehicle 105 has moved from a road area to a parking area 200, the vehicle computer 110 enables the valet mode from a disabled state to an enabled state. Additionally, the vehicle computer 110 can maintain the valet mode in the enabled state upon determining that the vehicle 105 remains in the parking area 200. In the enabled state, the vehicle computer 110 can accept requests to operate the vehicle 105 in the valet mode, e.g., through the parking area 200 to a pick-up location. In the disabled state, the vehicle computer 110 can ignore requests to operate the vehicle 105 in the valet mode. Upon enabling the valet mode, the vehicle computer 110 maintains a current position of the vehicle 105. The process 500 continues in a block 520.

In the block 520, the vehicle computer 110 determines whether a request to operate the vehicle 105 in the valet mode has been received. The vehicle computer 110 110 can monitor a network 135 to detect the request, e.g., from a remote server computer 140, a user device, etc. If the vehicle computer 110 receives the request to operate the vehicle 105 in the valet mode, then the process 500 continues in a block 525. Otherwise, the process 500 remains in the block 520.

In the block525, the vehicle computer 110 operates the vehicle 105 in the valet mode to move through the parking area 200 based on the stored travel path P. For example, the vehicle computer 110 can actuate one or more vehicle components 125 to move the vehicle 105 along the stored travel path P based on operating parameters for each of the plurality of segments S. The vehicle computer 110 can access the stored travel path P, e.g., from a memory of the vehicle computer 110. As another example, the vehicle computer 110 can determine the stored travel path P based on a map. In such an example, the vehicle computer 110 can receive a map of the parking area 200, e.g., from a remote server computer 140, that specifies the stored travel path P. The process 500 continues in a block 530.

In the block 530, while operating the vehicle 105 along a segment S, the vehicle computer 110 determines whether a mobile object 220 intersects the segment S. The vehicle computer 110 can determine that the mobile object 220 intersects the segment S based on determining, via sensor 115 data, that the mobile object 220 is within a specified distance of the segment S, and/or upon determining a blind zone around a vehicle and a mobile object 220 therein, as discussed above. Additionally, or alternatively, the vehicle computer 110 can predict whether a future location of the mobile device 220 will intersect the segment S based on predicting, via sensor 115 data, that the mobile object 220 will be within a specified distance of the segment S, as discussed above.

Additionally, the vehicle computer 110 can determine whether a distance between the mobile object 220 and the vehicle 105 is within a distance threshold. The vehicle computer 110 can determine the distance between the mobile object 220 and the vehicle 105 based on sensor 115 data, as discussed above. If the mobile object 220 intersects the segment S and is within the distance threshold of the vehicle 105, then the process 500 continues in a block 535. If the mobile object 220 does not intersect the segment S or is outside of the distance threshold of the vehicle 105, then the process 500 continues in a block 570.

In the block 535, the vehicle computer 110 actuates a vehicle component 125 to avoid impacting the mobile object 220 along the segment S. That is, the vehicle computer 110 performs a collision avoidance maneuver along the segment S. The process 500 continues in a block 545.

In the block 540, the vehicle computer 110 determines whether the segment S extends through an intersection of two or more lanes. The vehicle computer 110 can determine that the segment S extends through an intersection of two or more lanes based on map data and/or sensor 115 data, as discussed above. If the segment S extends through an intersection, then the process 500 continues in a block 545. Otherwise, the process 500 continues in a block 580.

In the bloc 545, the vehicle computer 110 determines whether the risk level for the segment S is at a highest risk level, e.g., “high” (or 3). If the risk level for the segment is at the highest risk level, then the process 500 continues in a block 575. If the risk level for the segment S is not at the highest risk level, then the process 500 continues in a block 550.

In the block 550, the vehicle computer 110 updates the risk level for the segment S. For example, the vehicle computer 110 can incrementally increase the risk level of the segment S, as discussed above. Additionally, the vehicle computer 110 updates operating parameters for the segment S based on the updated risk level, as discussed above.

Additionally, the vehicle computer 110 can update a map of the parking area 200 to specify the updated risk level for the segment S, as discussed above. The vehicle computer 110 can then provide the updated map to the remote server computer 140, which can update the map further based on aggregated data, as discussed above. The process 500 continues in a block 555.

In the block 555, the vehicle computer 110 operates the vehicle 105 to depart the segment S. That is, the vehicle computer 110 actuates one or more vehicle components 125 to move the vehicle 105 along the stored travel path P. The vehicle computer 110 operates the vehicle 105 along subsequent segments S based on the operating parameters for the respective segment S. The process 500 continues in a block 560.

In the block 560, the vehicle computer 110 operates the vehicle 105 along the stored travel path P to return to the segment S at a future time, e.g., the next day. In this situation, the vehicle computer 110 operates the vehicle 105 along segment S based on the updated vehicle operating parameters for the segment S. The process 500 continues in a block 565.

In the block 565, while operating the vehicle 105 along the segment S, the vehicle computer 110 determines whether a subsequent mobile object 220 intersects the segment S. The block 565 is substantially the same as the block 530 of process 500 and therefore will not be described further to avoid redundancy. If a subsequent mobile object 220 intersects the segment S and is within the distance threshold of the vehicle 105, then the process 500 returns to the block 535. If a subsequent mobile object 220 does not intersect the segment S or is outside of the distance threshold of the vehicle 105, then the process 500 continues in a block 570.

In the block 570, the vehicle computer 110 determines whether a timer has expired. For example, the vehicle computer 110 can initiate the timer upon updating the risk level for the segment S as discussed above. If the timer has not expired, then the process continues in a block 575. If the timer has expired, then the process 500 continues in a block 580.

In the block 575, the vehicle computer 110 maintains the risk level for the segment S. Additionally, the vehicle computer 110 maintains the operating parameters for the segment S. The process 500 continues in a block 585.

In the block 580, the vehicle computer 110 resets the risk level for the segment S. The vehicle computer 110 can, for example, reset the risk level to a lowest risk level, e.g., “low” (or 1). As another example, the vehicle computer 110 can incrementally decrease the risk level of the segment S. Additionally, the vehicle computer 110 can reset the operating parameters for the segment S based on the reset risk level, as discussed above.

Additionally, the vehicle computer 110 can update a map of the parking area 200 to specify the reset risk level for the segment S, as discussed above. The vehicle computer 110 can then provide the updated map to the remote server computer 140, which can update the map further based on aggregated data, as discussed above. The process 500 continues in a block 585.

In the block 585, the vehicle computer 110 operates the vehicle 105 along the travel path P based on the current vehicle operating parameters for each segment S. That is, the vehicle computer 110 can actuate one or more vehicle components 125 to move the vehicle 105 along the travel path P according to the operating parameters for each segment S of the travel path P. The process 500 ends following the block 585.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
operate a vehicle along a segment of a stored travel path based on vehicle operating parameters for the segment, the stored travel path including a risk level for the segment;
update the risk level for the segment based on actuating a vehicle component to avoid an object along the segment;
update the vehicle operating parameters for the segment based on the updated risk level; and
operate the vehicle along the segment based on the updated vehicle operating parameters.

2. The system of claim 1, wherein the instructions further include instructions to, upon updating the risk level for the segment, update a map to include the updated risk level.

3. The system of claim 2, wherein the instructions further include instructions to provide the updated map to a remote computer.

4. The system of claim 1, wherein the instructions further include instructions to determine the vehicle operating parameters for the segment based on the risk level for the segment.

5. The system of claim 1, wherein the instructions further include instructions to determine at least one of the vehicle operating parameters for the segment and the risk level for the segment based on operation data obtained while operating the vehicle along the segment in a training mode.

6. The system of claim 1, wherein the instructions further include instructions to determine the risk level for the segment based on receiving input specifying the risk level for the segment.

7. The system of claim 1, wherein the instructions further include instructions to update the risk level for the segment additionally based on determining that the segment extends through an intersection of two or more lanes.

8. The system of claim 1, wherein the instructions further include instructions to determine the stored travel path by recording a travel path along which the vehicle is operated in a training mode.

9. The system of claim 1, wherein the instructions further include instructions to determine, based on a map, the stored travel path.

10. The system of claim 1, wherein the instructions further include instructions to reset the updated risk level for the segment based on determining to not actuate the vehicle component to avoid a subsequent object along the segment for a predetermined time after actuating the vehicle component to avoid the object along the segment.

11. The system of claim 1, further comprising a remote computer including a second processor and a second memory, the second memory storing instructions executable by the second processor to update a map based on aggregated data including messages from a plurality of vehicles indicating the updated risk level of the segment.

12. A method, comprising:
operating a vehicle along a segment of a stored travel path based on vehicle operating parameters for the segment, the stored travel path including a risk level for the segment;
updating the risk level for the segment based on actuating a vehicle component to avoid an object along the segment;
updating the vehicle operating parameters for the segment based on the updated risk level; and
operating the vehicle along the segment based on the updated vehicle operating parameters.

13. The method of claim 12, further comprising, upon updating the risk level for the segment, updating a map to include the updated risk level and providing the updated map to a remote computer.

14. The method of claim 12, further comprising determining the vehicle operating parameters for the segment based on the risk level for the segment.

15. The method of claim 12, further comprising determining at least one of the vehicle operating parameters for the segment and the risk level for the segment based on operation data obtained while operating the vehicle along the segment in a training mode.

16. The method of claim 12, further comprising determining the risk level for the segment based on receiving input specifying the risk level for the segment.

17. The method of claim 12, further comprising updating the risk level for the segment additionally based on determining that the segment extends through an intersection of two or more lanes.

18. The method of claim 12, further comprising determining the stored travel path by recording a travel path along the vehicle is operated in a training mode.

19. The method of claim 12, further comprising determining, based on a map at least one of the stored travel path or the risk level for the segment.

20. The method of claim 12, further comprising resetting the updated risk level for the segment based on determining to not actuate the vehicle component to avoid a subsequent object along the segment for a predetermined time after actuating the vehicle component to avoid the object along the segment.
